(19) United States
(12) Patent Application Publication
(10) Pub. No.: US 2014/0063436 A1
(43) Pub. Date: Mar. 6, 2014

(54) MODULAR SUNGLASSES

(71) Applicants: Neil Anthony Bretl, Deerbrook, WI (US); Gary Bryan Barden, Wausau, WI (US)

(72) Inventors: Neil Anthony Bretl, Deerbrook, WI (US); Gary Bryan Barden, Wausau, WI (US)

(21) Appl. No.: 14/012,744

(22) Filed: Aug. 28, 2013

Related U.S. Application Data
(60) Provisional application No. 61/694,105, filed on Aug. 28, 2012.

(51) Int. Cl. G02C 11/02; G02C 13/00

(52) U.S. Cl. CPC G02C 11/02; G02C 13/001
USPC 351/51; 351/140; 351/178

(57) ABSTRACT

Modular glasses may include a first segment frame having a first segment lens area, an inner side and an outer side, wherein the inner side has a rail section. A second segment frame may also be included, having a second segment lens area, an outer side and an inner side, wherein the inner side has a notch section, wherein the notch section receives the rail section of the inner side of the first segment frame. A bottom catch may also be included below the notch section of the second segment frame.

### CROSS-REFERENCE TO RELATED APPLICATION

This application claims the benefit of priority of U.S. provisional application number 61/694,105, filed Aug. 28, 2012, the contents of which are herein incorporated by reference.

### BACKGROUND OF THE INVENTION

The present invention relates to glasses and sunglasses and, more particularly, to modular glasses and sunglasses.

It is costly to change the look of glasses or sunglasses. Currently other sets of glasses do not come apart. There is no opportunity to change only one part of a person's glasses or sunglasses. Currently, promotional glasses and sunglasses can only be used for specific events or items and then discarded.

As can be seen, there is a need for modular glasses that can be mixed and matched creating new looks.

### SUMMARY OF THE INVENTION

In one aspect of the present invention, a modular sunglasses comprises a first segment frame having a first segment lens area, an inner side and an outer side, wherein the inner side has a rail section; and a second segment frame having a second segment lens area, an inner side and an outer side, wherein the inner side has a notch section, wherein the notch section receives the rail section of the inner side of the first segment frame.

In another aspect of the present invention, a modular sunglasses comprises a first segment frame having a first segment lens area, an inner side and an outer side, wherein the inner side has a rail section; a second segment frame having a second segment lens area, an inner side and an outer side, wherein the inner side has a notch section and bottom catch; and a nose piece connection module having a first side with a notch section and a second side with a rail section, wherein the notch section of the nose piece connection module receives the rail section of the inner side of the first segment frame and the rail section of the nose piece connection module inserts into the notch section of the second segment frame.

In another aspect of the present invention, a method of putting together a modular sunglasses comprises the steps of: grasping a first segment frame; grasping a second segment frame; and sliding a rail section of the first segment frame into a notch section of the second segment frame.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is an exploded view of an alternate exemplary embodiment of the present invention;

FIG. 4 is a perspective detail view of an exemplary embodiment of the present invention;

FIG. 5 is a perspective detail view of an exemplary embodiment of the present invention;

FIG. 6 is a perspective view of an alternate exemplary embodiment of the present invention;

FIG. 7 is a section detail view of an exemplary embodiment of the present invention along line 7-7 in FIG. 6; and FIG. 8 is a section detail view of an exemplary embodiment of the present invention along line 8-8 in FIG. 6.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides modular glasses that may include a first segment frame having a first segment lens area, an inner side and an outer side, wherein the inner side has a rail section. A second segment frame may also be included, having a second segment lens area, an inner side and an outer side, wherein the inner side has a notch section, wherein the notch section receives the rail section of the inner side of the first segment frame. A bottom catch may also be included below the notch section of the second segment frame.

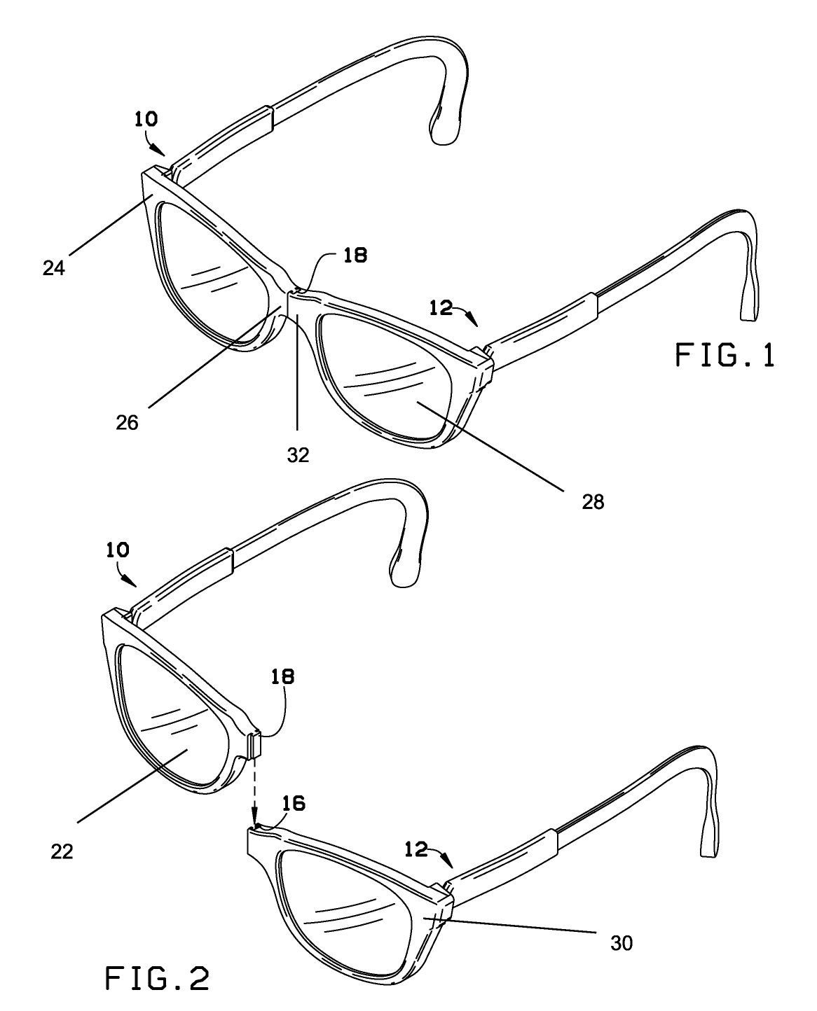

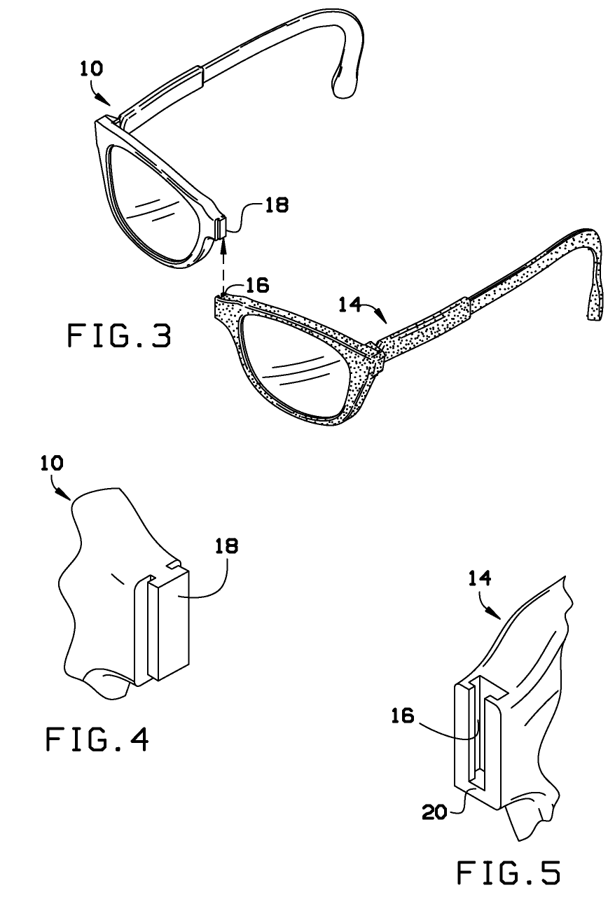

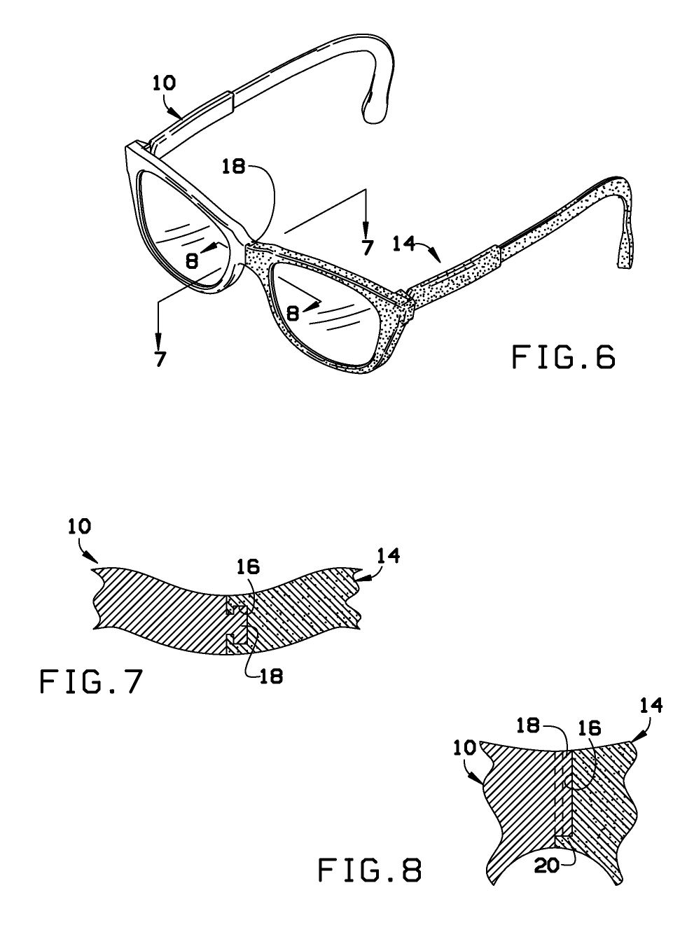

Referring now to FIGS. 1 through 8, the present invention may include a first segment frame 10 having a first segment lens area 22, an outer side 24 and an inner side 26. Along the inner side 26 of the first segment frame 10 may be a rail 18. A second segment frame 12 may be connected to the first segment frame 10. The second segment frame 12 may have a second segment lens area 28, an outer side 30 and an inner side 32. Along the inner side 32 of the second segment frame 12 may be a notch 16 and bottom catch 20. The rail 18 on the first segment frame 10 may be inserted into the notch 16 on the second segment frame 12 and seated on the bottom catch 20 of the second segment frame 12. When an individual switches the look of the modular glasses, the individual may exchange a first segment frame 10 or a second segment frame 12 for another. A second segment frame 12 may be replaced with another second segment frame 14 as is shown in FIG. 3 or a first segment frame 10 may be replaced with another first segment frame.

A method of making the modular glasses or sunglasses may start with injection molding a first segment frame and a second segment frame. The modular glasses sunglasses may be made my metal fabrication or acetate manufacturing, and the like depending on the materials used. In certain embodiments, the modular glasses or sunglasses may be taken apart and rejoined using different first segment frames and different second segment frames, making each combination different.

A method of using the modular glasses or sunglasses may include grasping the first segment frame and the second segment frame, sliding the rail section of the first segment frame into the notch section of the second segment frame until the rail section connects with the bottom catch of the second segment frame, connecting the two frames creating a complete pair of glasses or sunglasses.

In alternate embodiments, a nose piece connection module may be included in the modular glasses. The nose piece connection module may have a first side with a notch section and a second side with a rail section. The notch section of the nose piece connection module may receive the rail section of the inner side of the first segment frame and the rail section of the nose piece connection module may be inserted into the notch section of the second segment frame. This additional component may be used when the first segment lens area or the second segment lens area may be in a shape that may extend out from the area around the nose of the user.

In certain embodiments, the modular glasses may be glasses, bifocals, sunglasses, and the like. In certain embodiments, at least one decorative piece may be attached to the outer side of the first segment frame. At least one decorative piece may be attached to the outer side of the second segment frame as well. An example may include using promotional logos along each segment frame. Showing a home town fandom may include in certain embodiments, having a sports team logo on a first segment frame and a second sports team logo on a second segment frame. In certain embodiments the first segment frame and the second segment frame may have different shapes such as a star shape, a lightening shape, a cloud shape and the like.

It should be understood, of course, that the foregoing relates to exemplary embodiments of the invention and that modifications may be made without departing from the spirit and scope of the invention as set forth in the following claims.

What is claimed is:

1. A modular sunglasses comprising:
a first segment frame having a first segment lens area, an outer side and an inner side, wherein the inner side has a rail section; and
a second segment frame having a second segment lens area, an outer side and an inner side, wherein the inner side has a notch section, wherein the notch section receives the rail section of the inner side of the first segment frame.

2. The modular sunglasses of claim 1, further comprising a bottom catch along the inner side of the second segment frame below the notch section.

3. The modular sunglasses of claim 1, further comprising at least one decorative piece attached to the outer side of the first segment frame.

4. The modular sunglasses of claim 1, further comprising at least one decorative piece attached to the outer side of the second segment frame.

5. The modular sunglasses of claim 1, wherein the second segment frame is in a star shape.

6. The modular sunglasses of claim 1, wherein the second segment lens area is in a lightening shape.

7. The modular sunglasses of claim 1, wherein the second segment lens area is in a cloud shape.

8. A modular sunglasses comprising:
a first segment frame having a first segment lens area, an outer side and an inner side, wherein the inner side has a rail section;
a second segment frame having a second segment lens area, and outer side and an inner side, wherein the inner side has a notch section and bottom catch; and
a nose piece connection module having a first side with a notch section and a second side with a rail section, wherein the notch section of the nose piece connection module receives the rail section of the inner side of the first segment frame and the rail section of the nose piece connection module inserts into the notch section of the second segment frame.

9. A method of putting together a modular sunglasses comprising the steps of:
grasping a first segment frame;
grasping a second segment frame; and
sliding a rail section of the first segment frame into a notch section of the second segment frame.
